(19) United States
(12) Patent Application Publication
(10) Pub. No.: US 2018/0018292 A1
(43) Pub. Date: Jan. 18, 2018

(54) METHOD AND APPARATUS FOR DETECTING AND RESOLVING BUS HANG IN A BUS CONTROLLED BY AN INTERFACE CLOCK

(71) Applicant: QUALCOMM INCORPORATED, SAN DIEGO, CA (US)

(72) Inventors: KIRAN KUMAR MALIPEDDI, SECUNDERABAD (IN); YOSSI AMON, KIRYAT TIVON (IL); GRAHAM ROFF, SAN DIEGO, CA (US); CHRISTOPHER KONG YEE CHUN, AUSTIN, TX (US); RAJESH CHAVA, KHAMMAM (IN)

(21) Appl. No.: 15/209,416

(22) Filed: Jul. 13, 2016

(51) Int. Cl. G06F 13/24; G06F 1/32; G06F 1/24

(52) U.S. Cl. CPC G06F 13/24; G06F 1/24; G06F 1/3206

(57) ABSTRACT

Systems and methods are disclosed for resolving bus hang in a computing device. An exemplary system comprises a bus operating in accordance with an interface clock, and a controller in communication with the bus. The controller comprises a finite state machine, where the finite state machine is configured to receive a clock signal from the interface clock and a command signal originating external to the controller. The controller also comprising hang detection logic configured to receive one or more signals that the finite state machine is active, monitor the interface clock, and generate an event notification in response to the interface clock turning off while the finite state machine is active. The controller further comprises a trap handler in communication with the hang detection logic, the trap handler configured to send an interrupt in response to the event notification.

### DESCRIPTION OF THE RELATED ART

Computing devices comprising at least one processor coupled to a memory are ubiquitous. Computing devices may include personal computing devices (PCDs) such as desktop computers, laptop computers, portable digital assistants (PDAs), portable game consoles, tablet computers, cellular telephones, smart phones, and wearable computers. In order to meet the ever-increasing processing demands of users, PCDs increasingly incorporate multiple processors or cores running instructions or threads in parallel.

Such PCDs often include multiple finite state machines (FSM) as part of various systems or subsystems of the PCD, including for example, in association with power up, autonomous charging, and other functions requiring digital command signals. Finite state machines require a valid input clock in order to sequence through the intended states and operate properly. If the clock signal is not valid or turned off for some reason during the operation of the finite state machine, the finite state machine becomes stuck or hung in a fixed, unknown state.

Finite state machines interact with a bus using an interface clock for the bus to transmit or receive commands and/or data. If the signal for the interface clock is not valid or is turned off, then the bus is stuck or hung and any further transactions on the bus are not possible. Recovering the finite state machine, and the bus, requires a hard reset or battery removal. Additionally, when a finite state machine becomes hung, resulting in the bus hang, there is very limited visibility into the internal state of the finite state machine to diagnose the issue. This causes difficulties tracing the error that caused the finite state machine and bus to hang and/or reproducing the problem for diagnosing and resolving the issue.

Accordingly, there is a need for improved methods and apparatuses to detect when a finite state machine has become hung due to loss of the clock signal resulting in a hung bus, and to recover the finite state machine, and the bus, without the need for a hard reset.

### SUMMARY OF THE DISCLOSURE

Apparatuses, systems, methods, and computer programs are disclosed for detecting and resolving bus hang in a bus controlled by an interface clock are disclosed. The apparatuses, systems, methods, and or computer programs detect that a finite state machine operating on the interface clock is in a hung or unknown state due to signal clock failure from the interface clock, and allow for recovering the finite state machine and the bus, from the hung state without the need for a reset.

An exemplary system comprises a bus of a computing device, the bus operating in accordance with an interface clock, and a controller in communication with the bus. The exemplary controller comprises a finite state machine in communication with the bus, where the finite state machine configured to receive a clock signal from the interface clock and a command signal originating external to the controller. The exemplary controller also comprises hang detection logic. The hang detection logic is configured to receive one or more signals that the finite state machine is active, monitor the interface clock, and generate an event notification in response to the interface clock turning off while the finite state machine is active. The exemplary controller further comprises a trap handler in communication with the hang detection logic, where the trap handler is configured to send an interrupt in response to the event notification.

In another embodiment, a method for resolving bus hang in a bus of a computing device, the method comprising is provided. The exemplary method comprises receiving one or more signals that a finite state machine of the computing device is active, an output of the finite state machine in communication with the bus; monitoring an interface clock of the bus, the interface clock providing an input signal to the finite state machine; generating an event notification in response to the interface clock turning off while the finite state machine is active; sending an interrupt in response to the event notification; and performing a recovery operation in response to the interrupt.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system implementing detection of and recovery from a hung finite state machine;

FIG. 2 is a functional diagram showing an exemplary interaction of portions of the system of FIG. 1 during operation;

FIGS. 3A-3B are state diagrams of an exemplary finite state machine with which the present systems and methods may operate;

FIG. 4 is a flowchart illustrating an exemplary method for detecting that a finite state machine is hung;

FIG. 5 is a flowchart illustrating an exemplary method for recovering from a finite state machine that is hung; and

FIG. 6 is a block diagram of an exemplary computing device in which the system of FIG. 1 portions of FIG. 2, and/or methods of FIGS. 4-5 may be implemented.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “computing device” is used to mean any device implementing a processor (whether analog or digital) in communication with a memory, such as a desktop computer, gaming console, or server. A “computing device” may also be a “portable computing device” (PCD), such as a laptop computer, handheld computer, or tablet computer. The terms PCD, “communication device,” “wireless device,” “wireless telephone”, “wireless communication device,” and “wireless handset” are used interchangeably herein. With the advent of third generation (“3G”) wireless technology, fourth generation (“4G”), Long-Term Evolution (LTE), etc., greater bandwidth availability has enabled more portable computing devices with a greater variety of wireless capabilities. Therefore, a portable computing device may also include a cellular telephone, a pager, a smartphone, a navigation device, a personal digital assistant (PDA), a portable gaming console, a wearable computer, or any portable computing device with a wireless connection or link.

In order to meet the ever-increasing processing demands placed on PCDs, within the small form factors, PCDs increasingly incorporate multiple processors or cores (such as central processing units or “CPUs”) running various threads in parallel. Such PCDs often include multiple finite state machines (FSM) as part of various systems or subsystems of the PCD. FSMs require a valid input clock in order to sequence through the intended states of the FSM and operate properly. The input clock for the FSM may be an interface clock controlling a bus or interconnect over which the FSM communicates. Additionally, FSMs require a digital signal, such as a read/write signal, a transmit data signal, other command signal, or data signal that directs the FSM to perform the desired action.

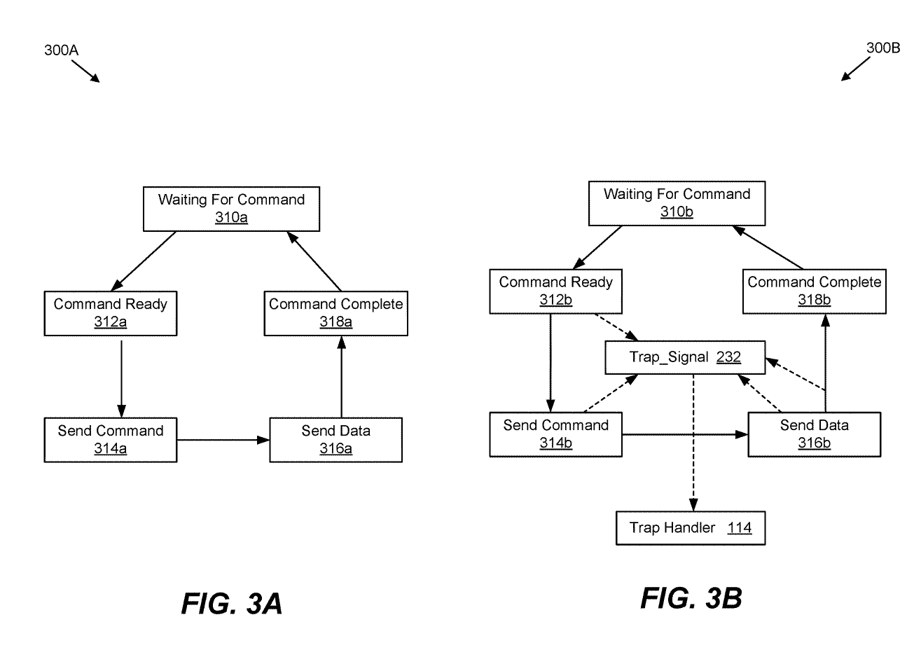

As mentioned, in operation a FSM sequences among various pre-defined states. FIG. 3A illustrates an exemplary state diagram for an embodiment of a FSM. As shown in the FIG. 3A, the FSM starts, and ends, in a ready state illustrated as Waiting for Command 310a. When a command is received, the FSM may sequence to the next state, Command Ready 312a, where the FSM processes the received command. The FSM may next sequence to a Send Command state 314a where the command is sent to one or more other component, system, application, process, etc. of the PCD.

Next the FSM may sequence to a Send Data state 316a where, in accordance with the received command, data is sent to one or more recipient component, system, application, process, etc. component, system. When the command has been executed, the FSM may sequence to a Command Complete state 318a where a signal may be sent and/or a bit set to indicate that the FSM has executed the received command. The FSM may then sequence back to the ready state Waiting for Command 310a. As will be understood, the state illustrated in FIG. 3A are illustrative, and other embodiments of an FSM may have more, fewer, and/or different states than those illustrated.

FSMs may be used for a wide variety of purposes. Example uses of a FSM include a controller for a power management integrated circuit (PMIC) for power management, in a controller for a camera of the PCD, in a controller for one or processors of the PCD, such as a graphical processing unit (GPU), etc. The present apparatuses, systems, and methods, are applicable to any such uses of a FSM that uses (i.e. has as an input) an interface clock of a synchronous serial communication interface bus or interconnect.

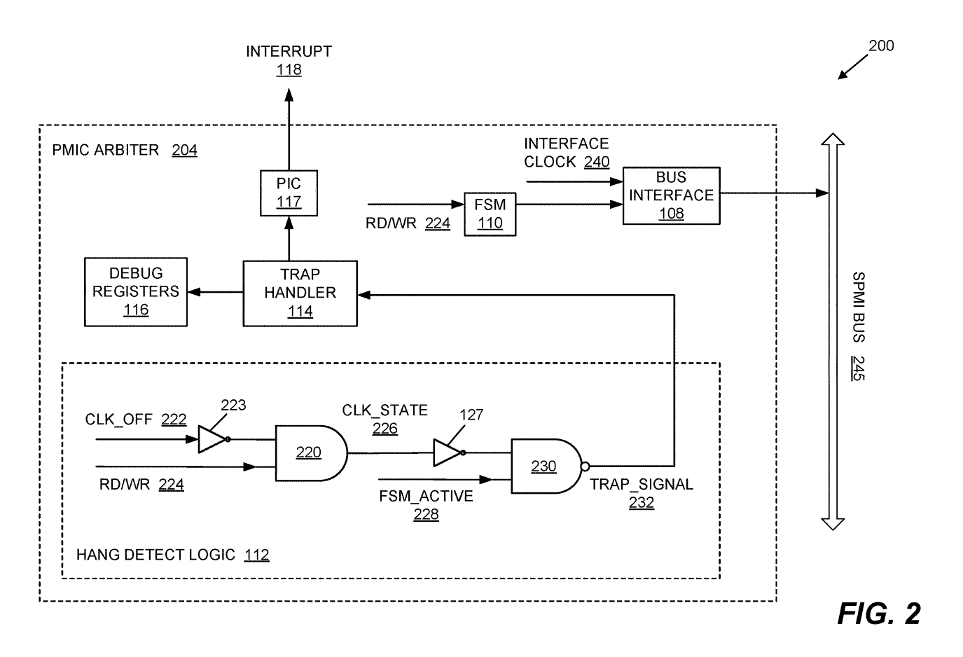

As is understood, when the FSM is operating (e.g. executing the states illustrated in FIG. 3A discussed above), if the interface clock providing an input signal to a bus (such as via Bus Interface 108 using Interface Clock 240 in FIG. 2) is invalid or turned off, the interface for the bus gets stuck and the FSM goes into an unknown/hang state. When the FSM is in this unknown state, no further transactions on the bus are possible. The system and methods of the present disclosure implement a hardware solution that detects when the FSM has become hung due to an invalid/turned off interface clock, resulting in a hung bus. The hardware logic detects an interface clock clock_off signal when the FSM is active, and generates a notification. The notification may be a trap signal to a trap handler. Upon receiving the trap signal, the trap handler may update relevant debug status registers with information about the FSM hang. The trap handler may also send a signal, such as an interrupt, to software executing on the PCD to allow recovery of the FSM and the bus.

Such rapid detection and recovery of an unknown/hung condition of an FSM provides several benefits not possible with current solutions. For example, the systems and methods of the present disclosure allow for recovery from the hung FSM and the hung bus, without reset of the PCD and/or a system-on-a-chip (SoC) of the PCD, resulting in an improved user experience. Additionally, rapid detection of the hung FSM and recovery/debug via software allows for much quicker and easier diagnosis of commands or situations that cause the interface clock to turn off, and the FSM and bus to hang, than are possible with current solutions.

Although discussed herein in relation to PCDs, the systems and methods herein—and the considerable savings made possible by the systems and methods—are applicable to any computing device.

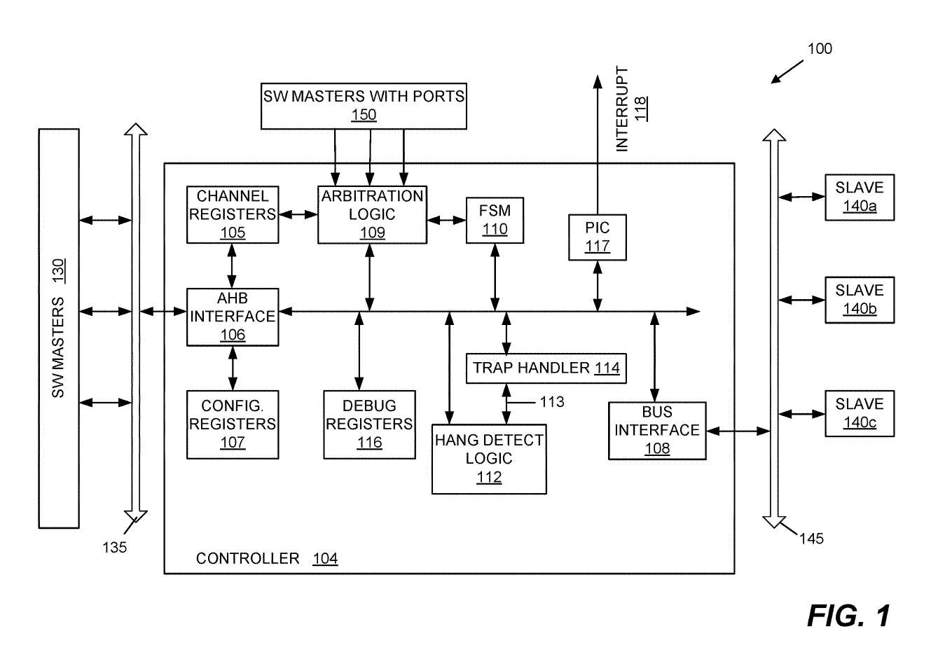

FIG. 1 is a block diagram of an embodiment of a system 100 implementing detection of and recovery from a hung finite state machine in a computing device. In an embodiment, the system 100 may be implemented on, or as a portion of, a system-on-a-chip (SoC) of the computing device. The system 100 may be implemented in any computing device, including a personal computer, a workstation, a server, or a PCD. The system 100 may also be implemented in a computing device that is a portion/component of another product such as an appliance, automobile, airplane, construction equipment, military equipment, etc.

As illustrated in the embodiment of FIG. 1, the system 100 comprises a controller 104 electrically coupled to one or more software masters 130 via an interconnect or bus 135. In an embodiment the interconnect or bus 135 may be an advanced high performance bus (AHB). The controller 104 is also electrically coupled to one or more slaves 140a-140c via a second interconnect or bus 145. In an embodiment the second interconnect or bus 145 comprises a synchronous serial communication interface bus or interconnect, such as a Serial Peripheral Management Interface (SPMI) bus. In the illustrated embodiment, the controller 104 is also electrically coupled to one or more second set of software masters 150 with dedicated ports to controller 104. These second set of software masters 150 may have the dedicated ports to the controller 104 so as to get higher priority than the first set of software masters 130. As illustrated in FIG. 1, the second set of software masters 150 with dedicated ports may provide inputs to arbitration logic 109 of controller 104.

The illustrated controller 104 comprises various components including an AHB interface 106, which may be a bridge to allow or control access between the controller 104 (or components of the controller 104) and the first bus 135. Controller also includes an additional bus interface 108 to allow or control access between the controller 104 (or components of the controller 104) and the second bus 145.

The AHB interface 106 may be coupled to various registers in some embodiments, such as configuration registers 107 that may contain configuration information for controller 104 received from one or more software masters 130. Additionally, in some embodiments AHB interface 106 may be coupled to channel registers 105 that may contain the command requests received at the controller 104 from one or more software masters 130. As illustrated in FIG. 1, the channel registers 105 may also be in communication with the arbitration logic 109, allowing the arbitration logic 109 to arbitrate or decide which among the various command requests from software masters 130 and/or second set of software masters 150 to process with controller 104.

The controller 104 also includes a FSM 110 implemented in hardware. The FSM 110 may be configured in any manner desired, and may include one or more states, such as states 310a-318a of FIG. 3A discussed above. As illustrated in FIG. 1 and FIG. 2, FSM 110 interacts with the Bus Interface 108 which receives as an input the interface clock of the second bus 145, which in the exemplary embodiment is a synchronous serial communication bus such as an SPMI bus (see FIG. 2). Similarly, in the illustrated embodiment, FSM 110 receives as another input a signal, such as a command signal, from one or more software masters 130 or second set of software masters 150. In an embodiment, the FSM 110 may receive this input signal from arbitration logic 109 as illustrated in FIG. 1. As a result of these inputs, FSM 110 provides an output to one or more slaves 140a-140c via the second bus 145.

As will be understood, in other embodiments FSM 110 may receive an input signal, such as a command signal, from more or different sources than those illustrated in FIG. 1, including from hardware sources in addition to (or instead of) software sources. Similarly, FSM 110 may provide output(s) to fewer, more, or different components than slaves 140a-140c illustrated in FIG. 1. Although referenced as master (130) and slave (140a-140c) in the embodiment of FIG. 1 which implements an SPMI bus for the second bus 145, in other embodiments the sources 130 and recipients 140a-140c may not have a master/slave relationship.

As shown in FIG. 1, the controller 104 also includes hang detection logic 112, which may be implemented in hardware, such as glue logic. Although illustrated as part of the controller 104 in FIG. 1, in other embodiments the hang detection logic 112 may be located elsewhere in system 100. The hang detection logic 112 operates on a different clock than the interface clock 240 (see FIG. 2) that provides the signal to the bus interface 108. In an embodiment the hang detection logic 112 may operate on an always-on (AON) clock. In operation, the hang detection logic 112 monitors the interface clock 240 that provides an input to bus interface 108 (see FIG. 2) to detect or determine when/if the interface clock 240 turns off or becomes invalid while the FSM 110 is active. If hang detection logic 112 detects or determines such an occurrence, it is assumed that the FSM 110—and the bus controlled by interface clock 240, such as bus 145 in FIG. 1—have become hung.

Hang detection logic 112 is configured to then generate an event notification 113. In an embodiment, the event notification 113 may be asynchronous and may comprise a signal regarding the clock state and/or a trap signal that is sent to another component such as a trap handler 114. Trap handler 114 may be implemented in hardware, software, or both. In an embodiment, trap handler 114 may be implemented in hardware, such as a sequence in register-transfer level (RTL) for one or more registers of the controller 104. In other embodiments, the trap handler 114 may not be located on the controller 104.

The trap handler 114 is in communication with one or more debug register 116. On receiving an event notification 113 from hang detection logic 112, the trap handler 114 may be configured to cause information to be written to one or more of the debug registers 116. In an embodiment, trap handler 114 may write a bit to one of the debug registers 116 indicating that the interface clock has stopped. Such information may be subsequently used to recover from the FSM 110 hang and bus 145 hang. In other embodiments, the trap handler 114 may write additional information to the debug registers 116, including information about the state of the FSM 110, an identity of the command being executed by the FSM 110 when the interface clock 240 (see FIG. 2) signal is stopped/turned off, etc. Such additional information may also be used in some embodiments to assist in recovery from the FSM 110 hang and bus 145 hang.

As discussed more below (see FIG. 2), in response to receiving the event notification 113 from the hang detection logic 112, the trap handler 114 may also cause an interrupt 118 to be sent. Interrupt 118 may be directed to software operating or executing on the PCD to inform the software of the FSM 110/bus 145 hang so that the software may recover from the hang condition. In an embodiment the interrupt 118 may be used by software to get information, such as a register address, directing the software to the debug register(s) 116 containing information about the event—e.g. one or more debug registers 116 where the trap handler 114 has written or placed information indicating that the interface clock 240 (see FIG. 2) has stopped/turned off, information about the state of the FSM 110, etc. As illustrated in FIG. 1 the interrupt 118 may be generated and/or sent by another component of the controller 104, such as a programmable interrupt controller (PIC) 117.

It will be understood that FIG. 1 is illustrative. As a result, the system 100 may include more, fewer, or different components than those illustrated in FIG. 1. Similarly, the controller 104 may include more, fewer, or different components than those shown in FIG. 1. Also, although illustrated as a controller 104 in the exemplary embodiment of FIG. 1, it will be understood that controller 104 may in other embodiments not be a controller, but may instead be any component of a PCD implementing an FSM 110 that receives an interface clock signal as an input.

Turning to FIG. 2, a functional diagram showing an exemplary interaction of components of a system 200 during operation is illustrated. The system 200 of FIG. 1 may be part of the system 100 of FIG. 1. In the embodiment of FIG. 2 the controller 104 is implemented as a power management integrated circuit (PMIC) arbiter/controller (referred to as PMIC arbiter 204). Similar to the controller 104 of FIG. 1, the PMIC arbiter 204 of FIG. 2 includes a FSM 110 as well as hang detection logic 112 in communication with a trap handler 114. Trap handler 114 is in communication with debug registers 116 and FSM 110. Trap handler 114 is also configured to cause one or more interrupt(s) 118 to be sent as discussed below, such as via PIC 117.

As will be understood, such PMIC arbiter 204 may be used to control the power distributed among the various components of a PCD. PMIC arbiter 204 may accomplish this control via a system power management interface (SPMI) bus 245 in communication with the PMIC arbiter 204. In the embodiment of FIG. 2, the SPMI bus 245 is a synchronous serial communication bus, and the interface clock of the SPMI bus 245 provides an interface clock signal 240 as an input to the bus interface 108. The FSM 110 may also receive the interface clock signal 240 as in input (not illustrated). The other input to the FSM 110 is a command signal, which in the illustrated embodiment is a read/write signal 224.

FIG. 2 also illustrates an exemplary embodiment of the hang detection logic 112 implemented in hardware, such as with glue logic. The exemplary embodiment of the hang detection logic 112 comprises an AND gate 220 coupled to a NAND gate 230. As illustrated in FIG. 2, the AND gate 220 receives two signals. The first input signal is the same command signal that is received by the FSM 110—in this implementation the read/write signal 224 that is also input in the FSM 110. The second signal received by the AND gate 220 is a clock_off signal 222 which reflects the state of the interface clock 240. Clock_off signal 222 comprises a signal indicating whether the interface clock for the SPMI bus 245—i.e. the interface clock providing interface clock signal 240 to bus interface 108 and FSM 110—is on or off. As will be understood, the clock_off signal 222 may indicate the state of the interface clock with a high/off or low/on value or by any other desired means.

As illustrated in FIG. 2, the clock_off signal 222 is fed into a first not gate 223 coupled to one input of the AND gate 220. When the interface clock is on (i.e. the interface clock signal 240 is being received by the FSM 110), clock_off signal will be off/low. By using the first not gate 223, the input into the first and gate 220 will be on/high when the clock_off signal 222 is low (i.e. the interface clock is operating). Thus, only when the FSM 110 is receiving a command input (read/write signal 224) and the interface clock signal 240 will the output of AND gate 220 will be true/high—i.e. only in this event will there be an output from AND gate 220, illustrated in FIG. 2 as clock_state signal 226. An illustrative truth table for the inputs to AND gate 220 for FIG. 2 is provided below in Table 1.

TABLE 1
AND Gate 220

| Clock_off signal 222 | Read/write signal 224 | Clock_state |
|---|---|---|
| (INV: 1 means clock is off) | (1 means signal present) | signal 226 |
| 0 | 0 | 0 |
| 1 | 1 | 0 |
| 1 | 0 | 0 |
| 0 | 1 | 1 |

As illustrated in Table 1 clock_state signal 226 is only true/high when the interface clock input into FSM 110 is on (clock_off signal 222 is 0) and the read/write signal 224 is being received by FSM 110 (read/write signal 224 is 1).

The clock_state signal 226 in FIG. 2, is fed into a second not gate 237 coupled to an input of the NAND gate 230. The other input to the NAND gate 230 is an FSM_active signal 228. FSM_active signal 228 is a signal indicating that the FSM 110 is active—i.e. is in a known state (see FIG. 3A) executing the received command (in this case read/write signal 224). The output of NAND gate 230 is trap_signal 232 which is input into trap handler 114 as illustrated in FIG. 2.

In this configuration, the output of the NAND gate 230 will always be on/high, until the interface clock turns off (clock_state signal 226 is 0 and turned to 1 by second not gate 237) while the FSM 110 is active (FSM_active signal 228 is 1). An illustrative truth table for the inputs to NAND gate 230 for FIG. 2 is provided below in Table 2.

TABLE 2
NAND Gate 230

| Clock_state signal 226 | FSM_active signal 228 | |
|---|---|---|
| (INV: 1 means clock is off) | (1 means signal present) | Trap_signal 232 |
| 0 | 0 | 1 |
| 0 | 1 | 1 |
| 1 | 0 | 1 |
| 1 | 1 | 0 |

Thus, with this exemplary configuration of hang detection logic 112 logic illustrated in FIG. 2, the trap_signal 232 is high/on until an event occurs where the interface clock 240 turns off while the FSM 110 is active. If that event occurs, the hang interface logic 12 detects that event and causes trap_signal 232 to turn low/off. Turning trap_signal 232 to low/off may comprise an event notification to trap handler 114.

As will be understood other implementations of the logic for hang detection logic 112 beyond those illustrated in FIG. 2 are possible. For example, hang detection logic 112 could be implemented with just the clock_off signal 222, command signal 224, first not gate 223 and AND gate 220. As will be understood, yet other implementations of the hang detection logic 112 are also possible.

As discussed above for FIG. 1, once the event notification is provided to trap handler 114—such as by trap_signal 232 turning off/low—trap handler 114 may record information about the event, such as by writing or placing information into one or more debug registers 116 in communication with trap handler 114. In an embodiment, such information may be writing a bit to a debug register 116 that would be understood to indicate that the interface clock 240 for SPMI bus 245 has stopped.

Additionally or alternatively, trap handler 114 may write or place other information into one or more of debug registers 116, such as information about which command FSM 110 was executing then FSM 110 and SPMI bus 245 became hung. Such information may be obtained from FSM 110. Such information may also or instead be obtained from hang detect logic 112 which also receives the command received by FSM 110, illustrated as read/write signal 224 in FIG. 2.

Trap handler 114 also causes an interrupt 118 to be sent to one or more destinations outside of the PMIC arbiter 204, providing visibility to external components and/or software that the hang event has occurred. In an embodiment, the trap handler 114 may cause PIC 117 to generate and send the interrupt 118. The interrupt 118 may contain information to allow another component and/or software to recover the hung FSM 110 and hung bus 245 without performing a hard reset of the PCD (or of an SoC). Such information may be contained within the interrupt 118. Alternatively, the interrupt 118 may direct the external component and/or software to the debug register(s) 116 where the trap handler 114 has stored information about the event.

FIG. 3B is an exemplary state diagram for a finite state machine, with states 310b-318b similar to states 310a-318a shown in FIG. 3A and discussed above. As illustrated in FIG. 3B, regardless of what state 310b-318b the finite state machine is in, or transitioning to, asynchronous trap_signal 232 is being sent to trap handler 114. Thus, regardless of the state 310b-318b, the hang detection logic 112 (see FIG. 2) may ensure that the finite state machine, and bus providing the interface clock signal to the finite state machine, have not become hung due to the interface clock signal turning off or being lost.

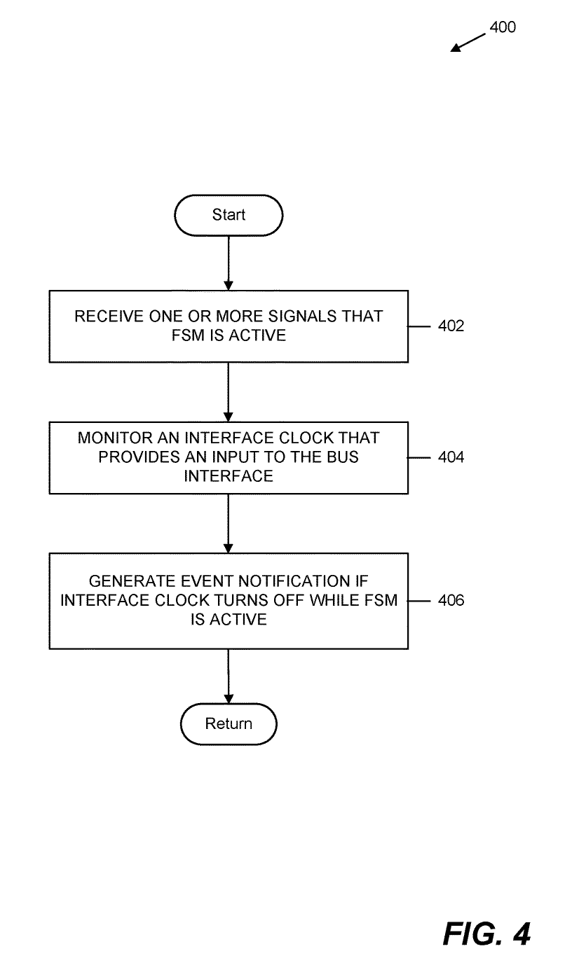

FIG. 4 is a flowchart illustrating an embodiment of a method 400 for is a flowchart illustrating an exemplary method for detecting that a finite state machine and/or bus providing the clock signal to the bus interface and finite state machine are hung. Method 400 begins in block 402 with the receipt of one or more signals indicating that a finite state machine is active. The finite state machine may be FSM 110 discussed above for FIG. 102. Additionally, block 402 may be performed in some embodiments by logic, such as the hang detection logic 112 of FIGS. 1-2.

The one or more signals indicating that FSM 110 is active in block 402 may comprise one or more signals received at the hang detection logic 112. As shown in the embodiment of FIG. 2, the one or more signals may comprise a command signal also received by the FSM 110 (illustrated as read/write signal 224) and/or the FSM_active signal 228. In some embodiments of the hang detection logic 112 the one or more signal of block 402 may indirectly indicate that the FSM 110 is active, such as the command received by the FSM 110 indicating that it is active (read/write signal 224). In other embodiments the one or more signal may instead, or alternatively, include a signal that directly indicates that the FSM 110 is active, such as FSM_active signal 228 (see FIG. 2).

Method 400 continues in block 404 where an interface clock that provides an input to the bus interface, such as an SPMI bus interface 108, is monitored. Referring back to FIG. 2, the bus interface 108 operates off of the interface clock for SPMI bus 245 as indicated by interface clock signal 240 received by bus interface 108. Hang detection logic 112 (and FSM 110) operates off of a different clock, such as an AON clock. In an embodiment, the monitoring of block 404 may be performed by the hang detection logic 112. Such monitoring may be performed by hang detection logic 112 monitoring a status of the interface clock 240/SPMI bus 245 clock. The monitoring may comprise the hang detection logic 112 receiving an indicator, such as clock_off signal 222 illustrated in FIG. 2 that indicates whether the interface clock sending signals to the bus interface 108 is on or off.

In block 406 an event notification is generated if the interface clock turns off while the finite state machine is active. In an embodiment, the hang detection logic 112 may generate the event notification, such as trap_signal 232 (see FIG. 2) that is provided to another component such as trap handler 114. In some implementations, the event notification may comprise a change in a signal sent to another component caused by the interface clock turning off.

For example, as discussed above for FIG. 2, trap_signal 232 may in some embodiments be sent continuously from the hang detection logic 112 to the trap handler 114. The hang detection logic 112 may be configured such that the trap_signal 232 is always high/on, unless a condition or event occurs where the interface clock turns off or is invalid while FSM 110 is active. In such event, the trap_signal 232 turns low/off as a result of the hang detection logic 112 detecting or determining that the interface clock is off, which in some embodiments comprises generating an event notification of block 406. Method 400 then returns and waits for the next signal to be received indicating (directly or indirectly) that the finite state machine (such as FSM 110) is active again and/or continues to be active.

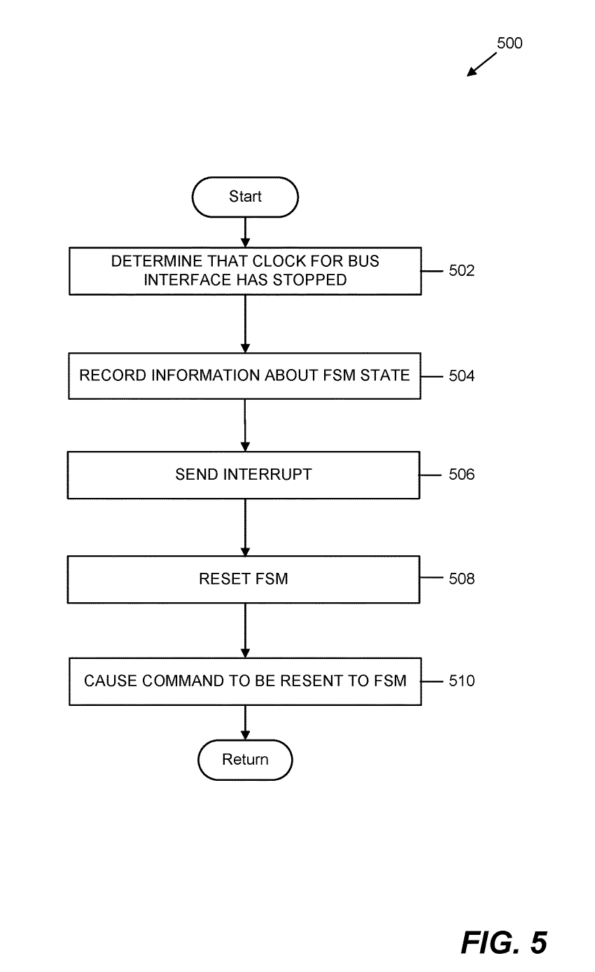

Turning to FIG. 5, this figure is a flowchart illustrating an exemplary method 500 for recovering from a finite state machine, and bus, that are hung. The exemplary method 500 may in some embodiments comprise steps or blocks that occur after a determination has been made that a finite state machine and/or bus providing a clock signal to the bus interface are hung. Such determinations of finite state machine or bus hang may be made (but is not required to be made) by method 400 of FIG. 4 discussed above.

Method 500 begins in block 502 where a determination is made that a clock for a bus interface has stopped. In an embodiment, this determination of block 502 may comprise a determination that an interface clock providing an input signal to the bus interface (such as bus interface 108). For example, as discussed above, a determination may be made that the clock for SPMI bus 245 which provides and interface clock signal 240 to bus interface 108 has stopped. Such determination may comprise a component such as trap handler 114 receiving a notification, such as a change in trap_signal 232 from hang detection logic 112 as discussed above for FIG. 2.

In block 504 information about the state of a finite state machine is recorded. Block 504 may comprise in some embodiments, a component such as trap handler 114 acting in response to an event notification from hang detection logic 112 to place or write information about the event into a memory or register such as debug registers 116 illustrated in FIG. 2. In an embodiment, trap handler 114 may write a bit to one of the debug registers 116 indicating that the interface clock, such as the clock of SPMI bus 245 of FIG. 2, has stopped. In other embodiments, the trap handler 114 may write additional information to the debug registers 116, including information about the state of the FSM 110, an identity of the command being executed by the FSM 110 when the input clock signal to bus interface 108 is stopped/turned off, etc. In some embodiments, such the embodiment illustrated in FIG. 2, the information recorded in block 504 may be received by the trap handler 114 from the hang detection logic 112 or may be obtained by the trap handler 114 from another source, such as from FSM 110.

Method 500 continues to block 506 where an interrupt is sent. In an embodiment, in response to receiving the event notification (such as a change in trap_signal 232 of FIG. 2) from the hang detection logic 112, the trap handler 114 may cause an interrupt 118 to be sent. Interrupt 118 may be directed to one or more component outside of the controller 104/PMIC arbiter 204 and/or software operating or executing outside of the controller 104/PMIC arbiter 204.

Interrupt 118 informs or alerts the external component(s) and/or the software of the FSM 110/bus 245 hang and/or the stoppage of the bus 245 clock so that the system may recover from the hang condition. In an embodiment the interrupt 118 may include information, such as a register address, directing the software to the debug register(s) 116 containing information about the event—e.g. one or more debug registers 116 where the trap handler 114 has written or placed information indicating that the interface clock has stopped/turned off, information about the state of the FSM 110, etc.

After receiving the interrupt the external component(s) and/or software may act to recover from the hung state, generally indicated in blocks 508-510 of method 500. In some embodiments the recovery may include more actions, fewer actions, or different actions than those illustrated in the exemplary blocks 508-510. Additionally, in various embodiments the actions may be taken in different order than illustrated by blocks 508-510 of FIG. 5.

In an embodiment the recovery may include resetting the finite state machine in block 508. Block 508 may be performed in an embodiment by one or more component or software external to the controller 104/PMIC arbiter 204 receiving the interrupt, acting in response to the interrupt, such as interrupt 118. The interrupt 118 itself may identify the finite state machine (such as FSM 110) that needs to be reset in block 508 some embodiments.

In other embodiments, the interrupt 118 may just indicate that an event has occurred. For such embodiments, the external component(s) or software may be directed to a memory location, such as one or more of debug registers 116 that contains information such as a bit indicating the nature of the event—e.g. that a particular interface clock has stopped, that a particular FSM 110 and/or bus 245 has hung, etc. Based on this information, the external component or software may determine what the event is, where the event occurred, what bus 245 clock or FSM 110 is involved, and/or to reset the FSM 110 (block 508).

Additionally, or alternatively, in response to the interrupt 118, the recovery may include causing one or more commands to be resent to the finite state machine in block 510. As will be understood, when a finite state machine, such as FSM 110 becomes hung or enters an unknown state any data being acted on by the FSM 110, such as data transmissions, is lost. As a result, the recovery in method 500 may also, or alternatively, include causing a retransmission to the FSM 110 of the digital signal that the FSM 110 was acting on when it became hung.

As will be understood, causing the command to be resent to FSM 110 may be accomplished in a variety of ways. For example, in the embodiment of FIG. 1 where one or more software masters 130 are providing digital signals to the FSM 110, block 510 may comprise determining, such as from information stored in debug registers 116 which digital signal caused the FSM 110 to become hung and/or which software master 130 was the source of the digital signal. For such embodiments, block 510 may further comprise causing the particular software master 130 to resend the digital signal to FSM 110, such as read/write signal 224 illustrated in FIG. 2. Similarly, block 510 may also comprise sending a communication or signal to the appropriate recipient/slave 140a-140c that a retransmission will be occurring. After the recovery steps of 508 and/or 510 (as well as any additional recovery steps) are completed, method 500 ends.

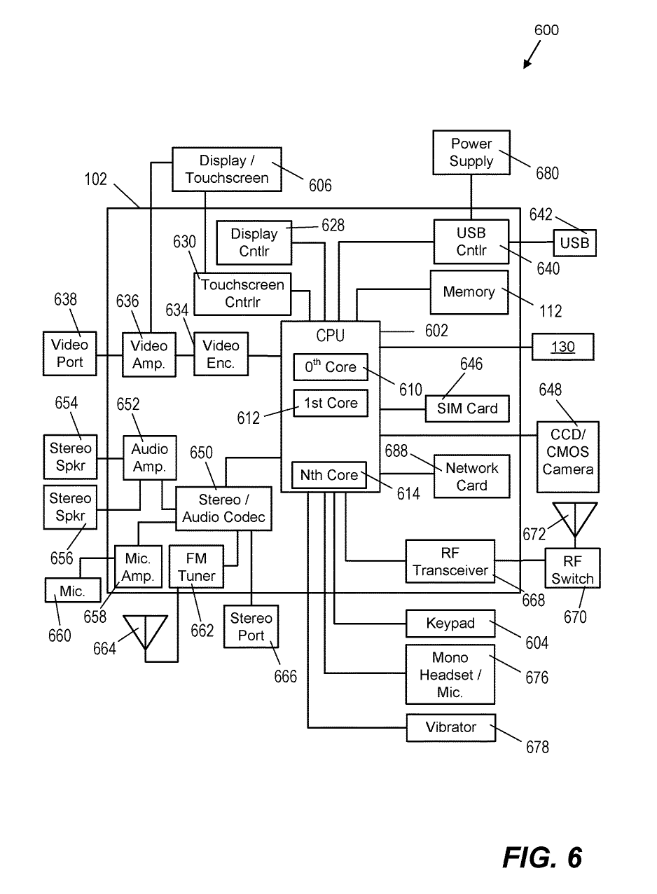

Systems 100 (FIG. 1) and 200 (FIG. 2), as well as methods 400 (FIG. 4) and/or 500 (FIG. 5) may be incorporated into or performed by any desired computing system, including a PCD. FIG. 6 illustrates an exemplary PCD 600 into which systems 100 and/or 200 may be incorporated, or that may perform methods 400, and/or 500. In the embodiment of FIG. 6, the PCD 600 includes a system-on-a-chip (SoC 102) that may comprise a multicore CPU 602. The multicore CPU 602 may include a zeroth core 610, a first core 612, and an Nth core 614, which may be CPUs 106a-106n of FIG. 1 or FIG. 2. One of the cores may comprise, for example, a graphics processing unit (GPU) with one or more of the others comprising the CPU.

A display controller 628 and a touch screen controller 630 may be coupled to the CPU 602. In turn, the touch screen display 606 external to the on-chip system 102 may be coupled to the display controller 628 and the touch screen controller 630. FIG. 6 further shows that a video encoder 634, e.g., a phase alternating line (PAL) encoder, a sequential color a memoire (SECAM) encoder, or a national television system(s) committee (NTSC) encoder, is coupled to the multicore CPU 602. Further, a video amplifier 636 is coupled to the video encoder 634 and the touch screen display 606.

Also, a video port 638 is coupled to the video amplifier 636. As shown in FIG. 6, a universal serial bus (USB) controller 640 is coupled to the multicore CPU 602. Also, a USB port 642 is coupled to the USB controller 640. Memory 112 and a subscriber identity module (SIM) card 646 may also be coupled to the multicore CPU 602.

Further, as shown in FIG. 6, a digital camera 648 may be coupled to the multicore CPU 602. In an exemplary aspect, the digital camera 648 is a charge-coupled device (CCD) camera or a complementary metal-oxide semiconductor (CMOS) camera.

As further illustrated in FIG. 6, a stereo audio coder-decoder (CODEC) 650 may be coupled to the multicore CPU 602. Moreover, an audio amplifier 652 may be coupled to the stereo audio CODEC 650. In an exemplary aspect, a first stereo speaker 654 and a second stereo speaker 656 are coupled to the audio amplifier 652. FIG. 6 shows that a microphone amplifier 658 may be also coupled to the stereo audio CODEC 650. Additionally, a microphone 660 may be coupled to the microphone amplifier 658. In a particular aspect, a frequency modulation (FM) radio tuner 662 may be coupled to the stereo audio CODEC 650. Also, an FM antenna 664 is coupled to the FM radio tuner 662. Further, stereo headphones 666 may be coupled to the stereo audio CODEC 650.

FIG. 6 further illustrates that a radio frequency (RF) transceiver 668 may be coupled to the multicore CPU 602. An RF switch 670 may be coupled to the RF transceiver 668 and an RF antenna 672. A keypad 604 may be coupled to the multicore CPU 602. Also, a mono headset with a microphone 676 may be coupled to the multicore CPU 602. Further, a vibrator device 678 may be coupled to the multicore CPU 602.

FIG. 6 also shows that a power supply 680 may be coupled to the on-chip system 102. In a particular aspect, the power supply 680 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 6 further indicates that the PCD 600 may also include a network card 688 that may be used to access a data network, e.g., a local area network, a personal area network, or any other network. The network card 688 may be a Bluetooth network card, a WiFi network card, a personal area network (PAN) card, a personal area network ultra-low-power technology (PeANUT) network card, a television/cable/satellite tuner, or any other network card well known in the art. Further, the network card 688 may be incorporated into a chip, i.e., the network card 688 may be a full solution in a chip, and may not be a separate network card 688.

Referring to FIG. 6, it should be appreciated that the memory 130, touch screen display 606, the video port 638, the USB port 642, the camera 648, the first stereo speaker 654, the second stereo speaker 656, the microphone 660, the FM antenna 664, the stereo headphones 666, the RF switch 670, the RF antenna 672, the keypad 674, the mono headset 676, the vibrator 678, and the power supply 680 may be external to the on-chip system 102 or “off chip.”

As discussed above, it will be understood that one or more of the components of the PCD 600 or SoC 102 listed above, including one or more of the “controllers”, may include or implement a finite state machine such as FSM 110. The systems 100/200 and methods 400/500 may be implemented in any such FSM 110 of PCD 600 or SoC 102 that operates on a synchronous interface clock, such as from one or more busses or interconnects of the PCD 600 or SoC 102.

It should be appreciated that one or more of the method steps described herein may be stored in the memory as computer program instructions. These instructions may be executed by any suitable processor in combination or in concert with the corresponding module to perform the methods described herein. Certain steps in the processes or process flows described in this specification naturally precede others for the invention to function as described.

However, the invention is not limited to the order of the steps or blocks described if such order or sequence does not alter the functionality of the invention. That is, it is recognized that some steps or blocks may performed before, after, or parallel (substantially simultaneously with) other steps or blocks without departing from the scope and spirit of the invention. In some instances, certain steps or blocks may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A computer system for resolving bus hang in a computing device, the system comprising:
a bus of the computing device, the bus operating in accordance with an interface clock; and
a controller in communication with the bus, the controller comprising:
a finite state machine in communication with the bus, the finite state machine configured to receive a clock signal from the interface clock and a command signal originating external to the controller,
hang detection logic, the hang detection logic configured to:
receive one or more signals that the finite state machine is active, monitor the interface clock, and
generate an event notification in response to the interface clock turning off while the finite state machine is active, and
a trap handler in communication with the hang detection logic, the trap handler configured to send an interrupt in response to the event notification.

2. The system of claim 1, wherein the event notification comprises a trap signal.

3. The system of claim 1, wherein the controller further comprises a debug register in communication with the trap handler, and wherein the trap handler is further configured to record information about the hang detection logic in response to the event notification.

4. The system of claim 1, further comprising software executed by a processor of the computing device in communication with the controller, wherein the trap handler is configured to send the interrupt to the software.

5. The system of claim 4, wherein the software is configured to perform a recovery operation in response to receiving the interrupt.

6. The system of claim 5, wherein the recovery operation comprises one or more of resetting the interface clock, resetting the finite state machine, or causing the command signal to be resent to the finite state machine.

7. The system of claim 1, wherein controller comprises a power management integrated circuit (PMIC).

8. The system of claim 1, wherein the one or more signals that the finite state machine is active comprises the command received by the finite state machine.

9. The system of claim 8, wherein the one or more signals that the finite state machine is active further comprises a second signal indicating that the finite state machine is active.

10. The system of claim 8, wherein the hang detection logic is further configured to monitor the interface clock by receiving a clock_off signal associated with the interface clock.

11. A method for resolving bus hang in a bus of a computing device, the method comprising:
receiving one or more signals that a finite state machine of the computing device is active, an output of the finite state machine in communication with the bus;
monitoring an interface clock of the bus, the interface clock providing an input signal to the finite state machine;
generating an event notification in response to the interface clock turning off while the finite state machine is active;
sending an interrupt in response to the event notification; and
performing a recovery operation in response to the interrupt.

12. The method of claim 11, wherein the receiving one or more signals, monitoring the interface clock, and generating the event notification are performed by a hang detection logic.

13. The method of claim 12, wherein the event notification comprises a trap signal sent to a trap handler in communication with the hang detection logic.

14. The method of claim 13, further comprising:
recording information about the finite state machine with the trap handler in response to the event notification.

15. The method of claim 13, wherein the hang detection logic, finite state machine, and trap handler are located in a power management integrated circuit of the PCD.

16. The method of claim 11, wherein the interrupt is sent by the trap handler to software executing on the PCD.

17. The method of claim 16, wherein the software performs the recovery operation in response to receiving the interrupt.

18. The method of claim 17, wherein the recovery operation includes one or more of resetting the interface clock, resetting the finite state machine, or causing a command signal to be resent to the finite state machine.

19. A computer program product comprising a non-transitory computer usable medium having a computer readable program code embodied therein, said computer readable program code adapted to be executed to implement a method for resolving bus hang in a bus of a computing device, the method comprising:
receiving one or more signals that a finite state machine of the computing device is active, an output of the finite state machine in communication with the bus;
monitoring an interface clock of the bus, the interface clock providing an input signal to the finite state machine;
generating an event notification in response to the interface clock turning off while the finite state machine is active;
sending an interrupt in response to the event notification; and
performing a recovery operation in response to the interrupt.

20. The computer program product of claim 19, wherein the receiving one or more signals, monitoring the interface clock, and generating the event notification are performed by a hang detection logic.

21. The computer program product of claim 20, wherein the hang detection logic and the finite state machine are located in a power management integrated circuit of a portable computing device.

22. The computer program product of claim 19, wherein the event notification comprises a trap signal.

23. The computer program product of claim 19, wherein the method further comprises:
recording information about the finite state machine in response to the event notification.

24. The computer program product of claim 19, wherein the recovery operation includes one or more of resetting the interface clock, resetting the finite state machine, or causing a command signal to be resent to the finite state machine.

25. A computer system for resolving bus hang in a computing device, the system comprising:
means for receiving one or more signals that a finite state machine of the computing device is active, an output of the finite state machine in communication with the bus;
means for monitoring an interface clock of the bus, the interface clock providing an input signal to the finite state machine;
means for generating an event notification in response to the interface clock turning off while the finite state machine is active;
means for sending an interrupt in response to the event notification; and
means for performing a recovery operation in response to the interrupt.

26. The system of claim 25, wherein the means for receiving one or more signals, means for monitoring the interface clock, and means for generating the event notification comprise a hang detection logic.

27. The system of claim 26, wherein the hang detection logic and the finite state machine are located in a power management integrated circuit of the computing device.

28. The system of claim 26, wherein the event notification comprises a trap signal sent to a trap handler in communication with the hang detection logic.

29. The system of claim 25, wherein the system further comprises:
means for recording information about the finite state machine in response to the event notification.

30. The system of claim 25, wherein the recovery operation includes one or more of resetting the interface clock, resetting the finite state machine, or causing a command signal to be resent to the finite state machine.
